(19) United States
(12) Patent Application Publication
(10) Pub. No.: US 2008/0186076 A1
(43) Pub. Date: Aug. 7, 2008

(54) Level detector, communication apparatus, and tuner

(75) Inventor: Shuichi Kawama, Kyoto-shi (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA

(21) Appl. No.: 11/976,857

(22) Filed: Oct. 29, 2007

(30) Foreign Application Priority Data
Feb. 1, 2007 (JP) 2007-023200

(51) Int. Cl. G06G 7/18; H04B 7/00

(52) U.S. Cl. 327/336; 455/239.1

(57) ABSTRACT

A level detector includes a comparing circuit and an integrating circuit. The comparing circuit generates pulses each having its width corresponding to the length of a time period during which the strength of an input signal is higher than a reference value. Alternatively, the comparing circuit may generate pulses each having its width corresponding to the length of a time period during which the strength of the input signal is lower than the reference value. The comparing circuit successively outputs the pulses. The integrating circuit outputs a signal having its strength corresponding to an integration value obtained by temporally integrating the signal from the comparing circuit.

### BACKGROUND OF THE INVENTION

1. Field of the Invention

The present invention relates to a level detector that outputs a signal to indicate the strength of an input signal, and also to a communication apparatus and a tuner including therein the detector.

2. Description of Related Art

In a receiving or transmitting circuit in a communication apparatus, the gain of an amplifier must be controlled in order that a received signal or a signal to be transmitted has the optimum level. For this purpose, a level detector is required to detect the average strength, that is, the average level, of the signal. For example, a level detector disclosed in Japanese Patent Unexamined Publication No. 2000-134163 outputs a received signal strength indication (RSSI) signal to indicate the strength of a received signal. The level detector of the publication has the following construction in order to reduce the detection error when the received signal varies on an envelope curve.

FIG. 10 shows a construction of the level detector of the above publication. In the level detector 900 of FIG. 10, a wave detector, using a diode, and a logarithm amplifier 901 wave-detects an input signal. The logarithm amplifier 901 is a circuit to compress the dynamic range of the signal strength. A peak holding circuit 902 then holds a peak value of the strength of the signal output from the logarithm amplifier 901 in order to obtain an envelope curve of the signal. In the case of an instantaneous peak value that appears in the signal due to, for example, noise contained in the signal, the peak holding circuit 902 can not hold the peak value because charging a charge/discharge circuit 903 provided for the peak holding circuit 902 requires a relatively long time. On the other hand, when the signal strength varies so as to form a gentle envelope curve, the peak value varies in the signal output from the peak holding circuit 902 because charging/discharging the charge/discharge circuit 903 can follow the variation in signal strength. An integrating circuit 904 integrates the variation in peak value to calculate an average envelope value. The level detector 900 outputs as the input signal strength the output signal of the integrating circuit 904.

The level detector 900 of the above publication having the above-described construction reduces the detection error to be generated due to nonlinearity of the level detector when the strength of the input signal varies on an envelope curve.

The level detector 900 is aimed at signals modulated by the phase shift keying (PSK) method or signals digital-modulated by a method in which the multiple number is relatively small, such as the code division multiple access (CDMA) method. The envelope curve of signals modulated by the PSK method is kept at a fixed value if there is no influence of fading. The envelope curve of signals modulated by the CDMA method somewhat varies in accordance with the multiple number. However, this can be coped with by optimizing the time constant corresponding to the circuit characteristics of the resistances and the capacitor in the charge/discharge circuit 903 of the level detector 900.

On the other hand, in a signal digital-modulated by, for example, the orthogonal frequency division multiplexing (OFDM) method, the instantaneous strengths are normally distributed. That is, the strength of the signal modulated by the OFDM method varies randomly. The lower the strength, the higher the frequency of appearance. A high strength appears with low frequency. More specifically, the instantaneous strength can be obtained from the characteristic of a normal distribution (N(0,sigma²)) where the mean is zero and the standard deviation, that is, the effective value, is sigma. For example, the frequency of appearance of a signal strength not less than 3.5 sigma is 0.03%. The value of 3.5 sigma is considered to be the minimum value of the dynamic range of the input to a demodulating circuit, necessary for demodulating an OFDM signal with substantially no error. The value of 0.03% of the appearance frequency is obtained when the signal is observed for a sufficiently long time. A strength not less than 3.5 sigma may appear in a relatively short time or may not appear for a relatively long time. In a signal demodulated by the OFDM method, however, because the signal band has been restricted, there is obtained no waveform in which the strength varies extremely sharply.

As a result, even when the envelope curve of such an OFDM signal and an average value of the envelope curve are obtained by the level detector 900, an accurate average value of the signal strengths can not be obtained. The reason will be described below.

Because the OFDM signal has been restricted in band, even in the case of a high strength not less than 3.5 sigma, which rarely appears, the peak waveform is not sharp. Therefore, even if such a high-strength component is intended to be removed, the waveform can not be distinguished from another low-strength waveform. Thus, the charge/discharge circuit 903 can not remove the high-strength component that rarely appears. As a result, the peak holding circuit 902 continues to hold the high-strength component in accordance with the discharge characteristic of the charge/discharge circuit 903. Thus, the level detector 900 outputs for a certain time a value widely different from the correct average strength. That is, the influence of the high-strength component that rarely appears is temporally expanded. On the other hand, if the discharge characteristic of the charge/discharge circuit 903 is designed to be fast, a peak can not be held even in the case of the variation of a low strength. As a result, the output of the level detector 900 continues to vary. This may make it impossible to obtain an average strength.

Consequently, the level detector 900 is unsuitable for a receiving circuit of a mobile communication device according to, for example, the OFDM method.

On the other hand, it is thinkable that the peak holding circuit 902 is not used and the output of the wave detector/logarithm amplifier 901 is input directly to the integrating circuit 904 so as to obtain an average value of not the envelope curve of the signal strengths but the signal strength absolute values or compressed signal strengths. In this case, however, the noise component contained in the signal is also integrated directly. Therefore, when the average strength of an OFDM signal input to the level detector 900 is low and the S/N ratio to noise generated in the receiving circuit is insufficient, the influence of the noise appearing in the integration result may increase. This makes it hard to accurately indicate the average strength of the received signal.

### SUMMARY OF THE INVENTION

An object of the present invention is to provide a level detector, a communication apparatus, and a tuner, in which the influence of noise has been suppressed to be suitable for a signal in which the instantaneous strength variously changes, such as an OFDM signal.

According to an aspect of the present invention, a level detector comprises a signal input; a comparing circuit that generates a signal comprising a plurality of temporally successive pulses each having its width corresponding to the length of a time period during which the strength of an input signal from the input is higher than a first reference value; and an integrating circuit that outputs a signal having its strength corresponding to an integration value obtained by temporally integrating the strength of the signal generated by the comparing circuit.

According to another aspect of the present invention, a level detector comprises a signal input; a comparing circuit that generates a signal comprising a plurality of temporally successive pulses each having its width corresponding to the length of a time period during which the strength of an input signal from the input is lower than a second reference value; and an integrating circuit that outputs a signal having its strength corresponding to an integration value obtained by temporally integrating the strength of the signal generated by the comparing circuit.

According to still another aspect of the present invention, a communication apparatus comprises an input to which a communication signal is input; a comparing circuit that generates a signal comprising a plurality of temporally successive pulses each having its width corresponding to the length of a time period during which the strength of the input signal from the input is higher than a predetermined reference value; and an integrating circuit that outputs a signal having its strength corresponding to an integration value obtained by temporally integrating the strength of the signal generated by the comparing circuit. The apparatus detects the level of the communication signal on the basis of the output from the integrating circuit.

According to still another aspect of the present invention, a tuner comprises an amplifier that amplifies an input signal and then outputs the amplified signal; a channel selecting unit that applies a channel selecting process to the signal output from the amplifier; a comparing circuit that generates a signal comprising a plurality of pulses each having its width corresponding to the length of a time period during which the strength of the signal channel-selecting-processed by the channel selecting unit is higher than a predetermined reference value; an integrating circuit that outputs a signal having its strength corresponding to an integration value obtained by temporally integrating the strength of the signal generated by the comparing circuit; and a gain controller that decreases the gain of the amplifier in accordance with the degree that the strength of the signal output from the integrating circuit is higher than a desired value; and increases the gain of the amplifier in accordance with the degree that the strength of the signal output from the integrating circuit is lower than the desired value.

According to the invention, the higher the average strength of the input signal, the higher the rate at which the instantaneous strength of the input signal is more than, or less than, the reference value. This increases the frequency of appearance of pulses, and thus increases the integration value by the integrating circuit. On the other hand, the lower the average strength of the input signal, the lower the rate at which the instantaneous strength of the input signal is more than, or less than, the reference value. This reduces the frequency of appearance of pulses, and thus decreases the integration value by the integrating circuit. Therefore, in the level detectors and the communication apparatus of the present invention, a signal can be output that properly indicates the average strength of the input signal even when the strength of the input signal variously changes, for example, in the case of an OFDM-modulated signal. In addition, in the tuner of the present invention, the gain of the amplifier is automatically properly controlled by using the level detector of the present invention.

The level detector of the present invention preferably further comprises a pulse width extending circuit that generates a signal in which each pulse contained in the signal generated by the comparing circuit has been temporally extended; and outputs the generated signal to the integrating circuit. This feature of the present invention is suitable for a case in which the signal strength is rarely more than, or less than, the reference value, for example, when extremely wide variation in the strength of an OFDM signal is detected. This is for the following reason. When the signal strength is rarely more than, or less than, the reference value, the frequency of appearance of pulses reduces. Therefore, even when the signal from the comparing circuit is directly integrated, the frequency of appearance of pulses is hard to reflect the integration result. In the above feature of the present invention, however, a narrow pulse in the signal from the comparing circuit is changed into a wide pulse by the pulse width extending circuit. As a result, the pulse having the extended width is integrated. This makes the frequency of appearance of pulses more surely reflect the integration result. In addition, because the strength of noise is lower than the strength of the target signal, the probability with which the strength of the noise is more than the reference value is very low. This realizes a level detector in which the influence of noise has been suppressed.

In the level detector of the present invention, the pulse width extending circuit may comprise a first diode to the anode of which the signal generated by the comparing circuit is input; a first resistor whose one end is connected to the cathode of the diode, and whose other end is grounded; and a capacitor whose one end is connected to the cathode of the diode, and whose other end is grounded, so that the pulse width extending circuit outputs to the integrating circuit a pulse having its width corresponding to the length of a time period during which the voltage being stored in the capacitor is higher than a reference voltage value. In this feature of the present invention, the capacitor is charged while a pulse is input through the cathode of the diode. After the input of the pulse ends, the capacitor is discharged, and the voltage of the capacitor gradually reduces. The pulse width extending circuit outputs a pulse having its width corresponding to the length of the time period during which the voltage being stored in the capacitor is higher than the predetermined reference voltage value. Thus, the pulse width extending circuit can output the pulse wider than the corresponding pulse contained in the signal from the comparing circuit.

In the level detector of the present invention, the pulse width extending circuit preferably further comprises a second diode having substantially the same circuit characteristics as the first diode; a second resistor having substantially the same circuit characteristics as the first resister; and a pulse width extending comparator. The pulse width extending comparator comprises,a first input terminal connected to the cathode of the first diode, and a second input terminal connected to both of the second diode and the second resistor. The pulse width extending comparator outputs to the integrating circuit a pulse corresponding to the length of a time period during which the voltage at the first input terminal is higher than the voltage at the second input terminal. In this case, the second diode and resistor are preferably connected to the second input terminal so as to reduce variation generated in the width of the pulse to be output from the pulse width extending comparator, due to at least one of the circuit characteristics and temperature variations of the first diode and resistor. The forward voltage of a diode may widely vary due to variations in the temperatures of the diode itself and the corresponding resistor, and the manufacturing variations in them. This may brings about variation in the time period for the discharge of the capacitor, and thus variation in the width of a pulse output from the pulse width extending circuit. In this feature of the present invention, however, the second diode and resistor having the same circuit characteristics as the respective first diode and resistor connected to the first terminal, are connected to the second terminal so as to reduce variation in the width of the pulse output from the pulse width extending circuit. This reduces variation generated in the pulse output from the pulse width extending circuit due to the circuit characteristics and the temperature variation.

A level detector of the present invention preferably comprises a signal input; a first comparing circuit that generates a signal comprising a plurality of temporally successive pulses each having its width corresponding to the length of a time period during which the strength of an input signal from the input is higher than a first reference value; a second comparing circuit that generates a signal comprising a plurality of temporally successive pulses each having its width corresponding to the length of a time period during which the strength of the input signal from the input is lower than a second reference value lower than the first reference value; an OR circuit that generates a signal having its strength corresponding to the logical sum of the signal generated by the first comparing circuit and the signal generated by the second comparing circuit; a pulse width extending circuit that generates a signal in which each pulse contained in the signal generated by the OR circuit has been temporally extended; and an integrating circuit that outputs a signal having its strength corresponding to an integration value obtained by temporally integrating the strength of the signal generated by the pulse width extending circuit. In this feature of the present invention, the OR circuit outputs a pulse in either of the case in which the strength of the input signal is higher than the first reference value; and the case in which the strength of the input signal is lower than the second reference value lower than the first reference value. Therefore, when the DC voltage of the input signal varies, the frequency of appearance of pulses increases in one of the first and second comparing circuits while the frequency of appearance of pulses decreases in the other of the first and second comparing circuits. Thus, even when the DC voltage varies, variation in the frequency of appearance of pulses is suppressed. This suppresses detection error in the signal strength.

A level detector of the present invention preferably comprises first to n-th signal inputs corresponding to n input signals, where n represents a natural number more than one; first to n-th comparing circuits each of which generates a signal comprising a plurality of temporally successive pulses each having its width corresponding to the length of a time period during which the strength of an input signal from the corresponding one of the first to n-th inputs is higher than a first reference value; an OR circuit that generates a signal having its strength corresponding to the logical sum of the signals generated by the first to n-th comparing circuits; a pulse width extending circuit that generates a signal in which each pulse contained in the signal generated by the OR circuit has been temporally extended; and an integrating circuit that outputs a signal having its strength corresponding to an integration value obtained by temporally integrating the strength of the signal generated by the pulse width extending circuit. This feature of the present invention is effective to a case in which the DC voltage increases in one of the input signals while the DC voltage decreases in another input signal. For example, when an DC offset voltage is generated between the components of a differential signal, the DC voltage of one component of the differential signal increases while the DC voltage of the other component of the differential signal decreases. In the above feature of the present invention, however, of the first to n-th comparing circuits, the frequency of appearance of pulses increases in the comparing circuit to which the signal whose DC voltage has increased while the frequency of appearance of pulses decreases in the comparing circuit to which the signal whose DC voltage has decreased. This eliminates the influence of the offset voltage on the frequency of appearance of pulses.

In the level detector of the present invention, it is preferable that the detector further comprises (n+1)th to 2n-th comparing circuits each of which generates a signal comprising a plurality of temporally successive pulses each having its width corresponding to the length of a time period during which the strength of the input signal from the corresponding one of the first to n-th inputs is lower than a second reference value lower than the first reference value, and the OR circuit generates a signal having its strength corresponding to the logical sum of the signals generated by the first to 2n-th comparing circuits. This feature of the present invention is effective to not only a case in which the DC voltage increases in one input signal while the DC voltage decreases in another input signal, but also a case in which all input signals contain uniform variation in the DC voltage. This is for the following reason. For example, when the DC voltages of all input signals increase, the frequency of appearance of pulses increases in the first to n-th comparing circuits while the frequency of appearance of pulses decreases in the (n+1)th to 2n-th comparing circuits.

### BRIEF DESCRIPTION OF THE DRAWINGS

Other and further objects, features and advantages of the invention will appear more fully from the following description taken in connection with the accompanying drawings in which:

FIG. 1 is a block diagram showing a general construction of a receiver according to a first embodiment of the present invention;

FIG. 2 is a block diagram showing a construction of a level detector included in the receiver of FIG. 1;

FIG. 3 is a circuit diagram showing respective specific constructions of a comparing circuit, a pulse width extending circuit, and an integrating circuit of FIG. 2;

FIG. 4 includes graphs showing changes in the respective voltage values at nodes A to E in the level detector of FIG. 2 when an OFDM signal is input to the level detector;

FIG. 5 is a block circuit diagram showing a modification of the level detector of FIG. 2;

FIG. 6 is a circuit diagram showing a construction of a pulse width extending circuit according to a second embodiment of the present invention;

FIG. 7 is a circuit diagram showing a construction of a comparing circuit according to a third embodiment of the present invention;

FIG. 8 is a circuit diagram showing a construction of a comparing circuit according to a fourth embodiment of the present invention;

FIG. 9 is a circuit diagram showing a construction of a comparing circuit according to a fifth embodiment of the present invention; and

FIG. 10 is a block diagram with a partial circuit diagram showing a construction of a prior art level detector.

### DESCRIPTION OF THE PREFERRED EMBODIMENTS

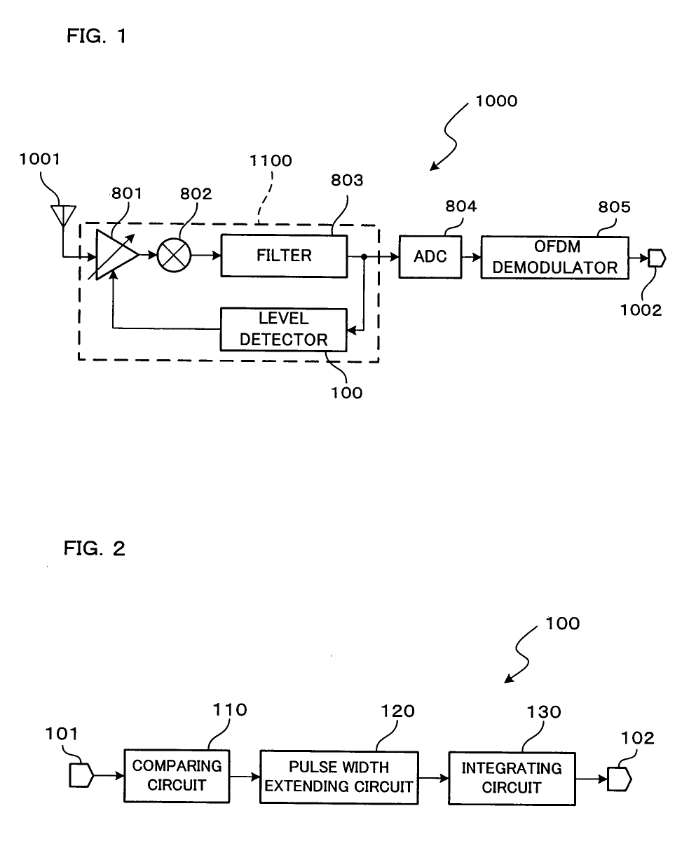

Hereinafter, preferred embodiments of the present invention will be described with reference to drawings. FIG. 1 is a block diagram showing a general construction of a receiver 1000 according to a first embodiment of the present invention.

### First Embodiment

The receiver 1000 includes an antenna unit 1001, a tuner unit 1100, an analog-to-digital converter (ADC) circuit 804, and an OFDM demodulator 805. An OFDM-modulated signal is input to the tuner unit 1100 through the antenna unit 1001. The tuner unit 1100 applies a channel selecting process to the OFDM-modulated signal. The channel-selecting-processed signal is input to the ADC circuit 804. The ADC circuit 804 converts the channel-selecting-processed signal from an analogue signal into a digital signal. The converted digital signal is input to the OFDM demodulator 805. The OFDM demodulator 805 demodulates the digital signal into a data string signal. The demodulated data string signal is output through an output terminal 1002 to the exterior of the receiver 1000.

The tuner unit 1100 includes therein a variable gain amplifier (VGA) 801, a mixer circuit 802, a filter circuit 803, and a level detector 100. The received signal sent from the antenna unit 1001 is amplified by the variable gain amplifier 801, and then input to the mixer circuit 802. The mixer circuit 802 frequency-converts the signal sent from the variable gain amplifier 801. The frequency-converted signal is input to the filter circuit 803. The filter circuit 803 extracts an OFDM signal of a target frequency band out of the frequency-converted signal. In this case, the filter circuit 803 serves as a channel selecting unit. For example, the receiver 1000 may be designed so that a channel indication signal is transmitted from a not-shown controller to the tuner unit 1100, and the filter circuit 803 extracts a signal of a frequency band corresponding to a channel indicated by the channel indication signal.

The frequency-converted signal from the filter circuit 803 is input to not only the ADC circuit 804 but also the level detector 100. The level detector 100 outputs to the variable gain amplifier 801 a signal having its strength corresponding to an average strength of the signal from the filter circuit 803. That is, in the tuner unit 1100, there is formed a feedback circuit in the order of the variable gain amplifier 801, the mixer circuit 802, the filter circuit 803, the level detector 100, and the variable gain amplifier 801. The feedback circuit is designed so that the gain of the variable gain amplifier 801 is automatically controlled so as to keep the strength of the output signal from the filter circuit 803 near a predetermined value. Hereinafter, the feedback circuit will be referred to as “automatic gain control (AGC) circuit”.

In the AGC circuit, the variable gain amplifier 801 is designed so as to automatically control its gain on the basis of the signal from the level detector 100. The variable gain amplifier 801 reduces its gain when the strength of the signal from the level detector 100 increases. Conversely, the variable gain amplifier 801 increases its gain when the strength of the signal from the level detector 100 decreases. For example, the variable gain amplifier 801 may be designed as follows. In the variable gain amplifier 801, a threshold has been set with respect to the signal from the level detector 100. The variable gain amplifier 801 increases its gain when the strength of the signal from the level detector 100 is less than the threshold, while the variable gain amplifier 801 reduces its gain when the strength of the signal from the level detector 100 is more than the threshold. More specific characteristics of the AGC circuit will be described later.

FIG. 2 is a block diagram showing a construction of the level detector 100. The level detector 100 includes therein a comparing circuit 110, a pulse width extending circuit 120, and an integrating circuit 130. The signal from the filter circuit 803 is input to the comparing circuit 110 through an input terminal 101. The signal from the integrating circuit 130 is output to the variable gain amplifier 801 through an output terminal 102.

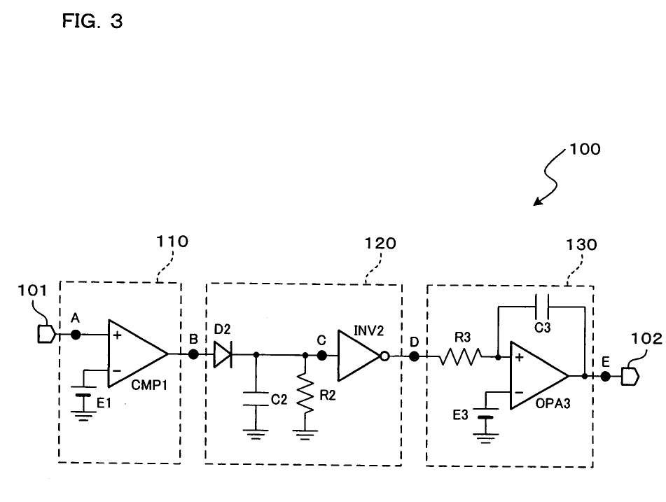

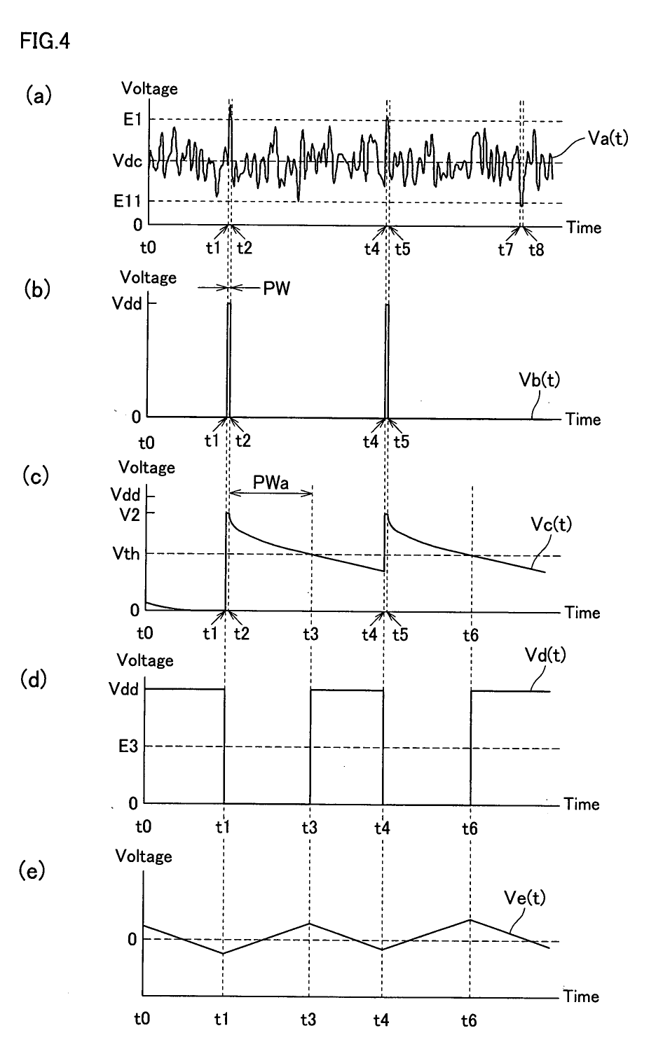

FIG. 3 is a circuit diagram showing respective specific constructions of the comparing circuit 110, the pulse width extending circuit 120, and the integrating circuit 130. The respective circuits are supplied with a power supply voltage Vdd, more than zero, from a not-shown single DC power supply. The ground voltage of 0 V is set in the respective circuits by grounding. At a not-shown position before an node A, a DC voltage Vdc, more than zero, is added to the input signal from the input terminal 101, as shown in the graph (a) of FIG. 4. This is for preventing the amplitude of the signal from being flattened in the case of a single power supply. In the below description, “E1” to “E11” mean the voltage values supplied from respective DC power supplies E1 to E11; “R2” to “R22” mean the resistance values of respective resistors R2 to R22; and “C2” and “C3” mean the capacitance values of respective capacitors C2 and C3. Any of those values is positive.

The comparing circuit 110 includes therein a comparator CMP1 and a DC power supply E1. The inverting input of the comparator CMP1 is connected to the positive terminal of the DC power supply E1. The non-inverting input of the comparator CMP1 is connected to the input terminal 101. The negative terminal of the DC power supply E1 is grounded. The value of E1 has been controlled to be more than the DC voltage Vdc of the received signal. The comparator CMP1 compares the inverting input voltage and the non-inverting input voltage with each other. The comparator CMP1 outputs the same voltage as the power supply voltage when the non-inverting input voltage is higher than the inverting input voltage. The comparator CMP1 outputs the ground voltage when the inverting input voltage is higher than the non-inverting input voltage. Therefore, the comparator CMP1 outputs a certain value of voltage Vdd only when a signal having its strength higher than a reference value E1, as a first reference value, is input through the input terminal 101. In the other cases, the comparator CMP1 outputs the ground voltage. Thus, the comparing circuit 110 outputs a pulse signal having its pulse width corresponding to the time period during which the voltage of the input signal exceeds E1.

The pulse width extending circuit 120 includes therein a diode D2, a capacitor C2, a resistor R2, and an inverter INV2. The anode of the diode D2 is connected to the output terminal of the comparator CMP1. Either of one ends of the capacitor C2 and the resistor R2 is connected to the cathode of the diode D2. Either of the other ends of the capacitor C2 and the resistor R2 is grounded. The input terminal of the inverter INV2 is connected to the cathode of the diode D2.

The inverter INV2 is designed so as to output zero when the input voltage is higher than a reference voltage Vth; and output Vdd when the input voltage is lower than the reference voltage Vth. That is, the inverter INV2 is a kind of comparator to compare two values. However, differently from the comparator CMP1, the inverter INV2 is designed so that the value of Vth is determined by the circuit construction of the inverter INV2 itself and the parameters of the elements of the construction. The input impedance of the inverter INV2 has been controlled so as to be very high in comparison with that of the resistor R2. That is, the inverter INV2 is designed so as to be hard to influence when the capacitor C2 is discharged through the resistor R2. A CMOS inverter is an example of such a high-impedance-input inverter. When the voltage in the forward direction of the diode D2 is Vf, the inverter INV2 is designed so that a condition of zero smaller than Vth smaller than (Vdd−Vf) is obtained.

When a signal is input to the pulse width extending circuit 120, the signal first passes through the diode D2. When a positive voltage is applied to the anode of the diode D2, the diode D2 is put in the conduction state. In this state, the capacitor C2 holds electric charges corresponding to the voltage at the cathode of the diode D2. On the other hand, when a negative voltage is applied to the anode of the diode D2, the diode D2 is put in the non-conduction state. In this state, the electric charges accumulated in the capacitor C2 are released through the resistor R2. Thereby, the voltage of the cathode of the diode D2 lowers.

The integrating circuit 130 includes therein a resistor R3, a capacitor C3, an operational amplifier OPA3, and a DC power supply E3. One end of the resistor R3 is connected to the output terminal of the inverter INV2; and the other end of the resistor R3 is connected to the inverting input of the operational amplifier OPA3. The non-inverting input of the operational amplifier OPA3 is connected to the positive terminal of the DC power supply E3. The negative terminal of the DC power supply E3 is grounded. One end of the capacitor C3 is connected to the inverting input of the operational amplifier OPA3; and the other end of the capacitor C3 is connected to the output terminal of the operational amplifier OPA3. The integrating circuit 130 is a general inverting input type integrator. That is, the integrating circuit 130 temporally integrates the strength of the signal from the pulse width extending circuit 120. The integrated value is output to the output terminal 102.

Next will be quantitatively described a relation between the strength of the signal output from the level detector 100 when an OFDM signal is input to the level detector 100, and the average strength of the input signal. FIGS. 4 includes five graphs (a) to (e) showing changes in the respective voltage values at nodes in the level detector 100 when an OFDM signal is input to the level detector 100. The graphs (a) to (e) shows the voltages Va(t) to Ve(t), where t represents time, at nodes A to E in FIG. 3, respectively. The node A corresponds to the input of the level detector 100; the node B corresponds to the output of the comparing circuit 110; the node C corresponds to the input of the inverter INV2 in the pulse width extending circuit 120; the node D corresponds to the output of the pulse width extending circuit 120; and the node E corresponds to the output of the level detector 100. In the graph (a), the values of Va(t) are more than E1 in time periods from t1 to t2 and from t4 to t5, and less than E11, less than Vdc, as will be described later, in a time period from t7 to t8. In the other time periods, Va(t) varies with taking any value between E11 and E1.

When the signal represented by Va(t) is input, the comparator CMP1 outputs a signal represented by Vb(t). That is, in either of the time periods from t1 to t2 and from t4 to t5, in which the values of Va(t) are more than E1, the comparator CMP1 outputs a pulse having its height of Vdd. In the other time periods, the comparator CMP1 outputs zero. The pulse width PW of such a pulse is not always fixed, however, an approximate value of the pulse width PW can be calculated. The waveform becomes sharp when exceeding the reference voltage E1. However, because the frequency band of the OFDM signal has been restricted, the pulse width PW is approximately obtained by the following Expression 1 where Fmax represents the maximum frequency of the signal component contained in the OFDM signal.

$$PW = \frac{1}{2 F max} \qquad [ Expression 1 ]$$

Next, when the signal represented by Vb(t) is input to the node B, that is, to the anode of the diode D2, the diode D2 is put in the conduction state in the time periods from t1 to t2 and from t4 to t5; and in the non-conduction state in the other time periods. In the conduction state, the voltage at the cathode of the diode D2, that is, at the node C, takes a fixed value V2=(Vdd−Vf), where V2 is more than zero. Thereby, the capacitor C2 holds electric charges corresponding to the voltage V2. On the other hand, in the non-conduction state, the electric charges accumulated in the capacitor C2 are released through the resistor R2. Therefore, the voltage at the node C gradually lowers from the time t2 and from the time t5. The voltage Vc(t) at the node C in FIG. 3 in either of the discharge periods from t2 to t4 and after t5, is obtained by the following Expression 2, where tx represents the start time of discharge.

Vc(t)=V2e^{-(t-tx)/C2-R2} [Expression 2]

When the signal represented by Vc(t) is input from the node C to the inverter INV2, the inverter INV2 outputs a signal represented by Vd(t). That is, the inverter INV2 outputs zero volt in either of the time periods from t1 to t3 and from t4 to t6, in which the value of Vc(t) is more than Vth; and the voltage Vdd in the other time periods, in any of which the value of Vc(t) is less than Vth. Thereby, as shown in the graph (d), the pulse width PW=(t2−t1) in Vb(t) is expanded to (t3−t1). Also, the pulse width PW=(t5−t4) in Vb(t) is expanded to (t6−t4).

In the pulse signal Vd(t), the pulses contained in Vb(t) are reversed with respect to an axis of V=Vth with their pulse widths being expanded. In a modification for not reversing the pulses, the pulse width extending circuit 120 may includes therein another inverter cascade-connected to the inverter INV2.

The pulse width increase quantity PWa=(t3−t2)=(t6−t5) is obtained from the following Expression 3 by substituting (t−tx)=PWa and Vc(t)=Vth in the above Expression 2.

$$PWa = C 2 R 2 log \frac{V 2}{Vth} \qquad [ Expression 3 ]$$

In the above Expression 3, “log” represents natural logarithm. Apparently from the above Expression 3, it is only necessary for increasing PWa to increase at least one of the parameters C2 and R2 of the time constant of discharge.

When the signal represented by Vd(t) is input from the node D to the integrating circuit 130, the integrating circuit 130 outputs a signal represented by Ve(t). That is, the integrating circuit 130 outputs a serrated signal as shown in the graph (e). It is assumed that either of the pulse widths of the voltage Vdd and the voltage zero in Vd(t) is sufficiently smaller than the time constant (C3×R3). In addition, Pd represents the ratio of the time period during which the voltage is zero, to the time period from the time zero to a time t in Vd(t). The parameter Pd corresponds to an average probability with which the voltage becomes zero in the time period from zero to t. In this case, the integrating circuit output Ve(t) is obtained by the following Expression 4, where the integrating circuit 130 is turned on at the time zero.

$$\begin{matrix}Ve ( t ) = \frac{1}{C 3 R 3} {\int }_{0}^{t} ( E 3 - Vd ( τ ) ) d τ \\ = \frac{Vdd Pd - ( Vdd - E 3 )}{C 3 R 3} t\end{matrix} \qquad [ Expression 4 ]$$

The pulse width of the voltage zero in Vd(t) is equal to (PW+PWa). Therefore, from the pulse width ratio, the ratio Pb of the time period during which the voltage is Vdd, to the time period from zero to t in Vb(t), is obtained by the following Expression 5. The parameter Pb corresponds to an average probability with which the voltage becomes Vdd in the time period from zero to t in Vb(t).

$$Pb = Pd \frac{PW}{PW + PWa} \qquad [ Expression 5 ]$$

When Pa represents the ratio of the time period during which the voltage is more than E1, to the time period from zero to t in Va(t), Pa=Pb. Therefore, from the above Expressions 4 and 5, a relation between the voltage Ve(t) and Pa of the level detector output according to the present invention is obtained by the following Expression 6.

$$Ve ( t ) = \{ VddPa \frac{PW + PWa}{PW} - ( Vdd - E 3 ) \} t / C 3 R 3 \qquad [ Expression 6 ]$$

The above Expression 6 indicates that an increase or decrease in Pa corresponds to an increase or decrease in Ve(t). As described above, Pa corresponds to the probability with which the voltage input to the level detector 100 is more than E1. As the strength, that is, the voltage, of the signal input to the level detector 100 increases, Pa increases accordingly. Contrastingly, as the strength decreases, Pa decreases accordingly. Therefore, an increase or decrease in Ve(t) indicates an increase or decrease in the average strength of the signal input to the level detector 100.

The signal strengths of an OFDM signal are normally distributed. Therefore, in an OFDM signal in which the DC voltage is Vdc and the effective value is Vev, the probability with which the voltage is more than E1 is obtained by the following Expression 7.

$$\begin{matrix}P a = \frac{1}{\sqrt{2 π} Vev} {\int }_{E 1}^{∞} {e}^{- {( x - Vdc )}^{2} / 2 {Vev}^{2}} d x \\ = \frac{1}{\sqrt{2 π}} {\int }_{( E 1 - Vdc ) / Vev}^{∞} {e}^{- {y}^{2} / 2} d y\end{matrix} \qquad [ Expression 7 ]$$

Thus, a set value of E1 necessary for setting Pa to a predetermined value when an OFDM signal having a distribution of effective values Vev, is derived from the above Expression 7.

Next will be more specifically described operations of the AGC circuit using the level detector 100 in the tuner unit 1100, as shown in FIG. 1. As described above, the AGC circuit controls the variable gain amplifier 801 so that the gain of the variable gain amplifier 801 reduces when the strength of the signal output from the level detector 100 increases; and the gain of the variable gain amplifier 801 increases when the strength of the signal output from the level detector 100 reduces. As will be understood from the above Expression 6, the higher the strength Ve(t) of the signal output from the level detector 100, the higher the strength of the signal output from the filter circuit 803. Therefore, the variable gain amplifier 801 reduces its gain in accordance with an increase in the strength of the signal output from the filter circuit 803; and increases its gain in accordance with a decrease in the strength of the signal output from the filter circuit 803. By this control, the AGC circuit keeps near a fixed value the strength of the signal output from the filter circuit 803. Hereinafter, a state in which the strength of the signal output from the filter circuit 803 is kept near the fixed value, as described above, will be referred to as “stationary state”.

$$VddPa \frac{PW + PWa}{PW} - ( Vdd - E 3 ) = 0 \qquad [ Expression 8 ]$$

It is assumed that the effective value of the OFDM signal from the filter circuit 803 is Vev in the stationary state. In this case, to set Pa to a relatively small value, for example, 1%, E1 can be set so as to satisfy a condition of E1=2.33 Vev+Vdc, from the above Expression 7. On the other hand, it is assumed that conditions of PWa=49 PW and E3=Vdd/2 have been set in order to satisfy the above Expression 8. The value of PW can be derived from the above Expression 1. The value of Fmax is the maximum value of the frequency band of the channel selecting process by the filter circuit 803. From the above conditions and the above Expression 3, the values of C2 and R2 are derived. That is, by setting the value of Pa and setting the values of PWa and E3 so as to satisfy the above Expression 8, it is derived how the parameters C2 and R2 of the time constant in the pulse width extending circuit 120 should be set. The time period necessary for realizing the stationary state by the AGC circuit depends on the time constant determined by the parameters C3 and R3 in the integrating circuit 130.

Next will be described a set range for E1. For example, it is assumed that the DC voltage Vdc is constant and an OFDM signal in which the effective value Vev is V0 is input to the level detector 100. Under these conditions, to set Pa to, for example, 10%, the value of E1 must be set so as to satisfy a condition of E1=1.28 V0+Vdc, from the above Expression 7.

It is further assumed that the average strength of the OFDM signal has increased from the above state so that the effective value Vev becomes 2 V0. In this case, when the value of E1 has been set so as to satisfy the condition of E1=1.28 V0+Vdc, the value of Pa becomes 26% as derived from the above Expression 7. On the other hand, when the effective value becomes V0/2, the value of Pa becomes 0.5%. A high value of Pa brings about a high density of pulses at the node B. This increases the possibility that pulses expanded by the pulse width extending circuit 120 overlap each other. This leads to an incorrect value of Pd. That is, the strength Ve(t) of the signal output from the level detector 100 does not accurately reflect the average strength of the OFDM signal. Therefore, on the basis of the range of values that the effective value of the OFDM signal can take, the value of E1 is preferably set so that pulses expanded by the pulse width extending circuit 120 overlap each other as little as possible.

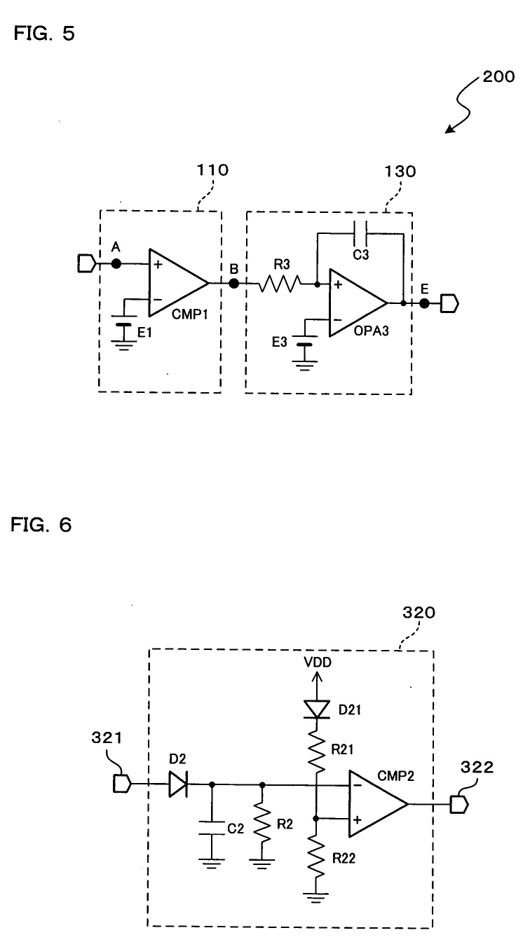

In a modification, such a pulse width extending circuit 120 can be omitted as in a level detector 200 of FIG. 5. In the level detector 200, the output terminal of the comparing circuit 110 is connected directly to the input terminal of the integrating circuit 130. In this modification, because no pulse width is expanded, PWa=0 in the above Expression 6. This suppresses overlapping of pulses in the signal to be input to the integrating circuit 130.

In the level detector 200, however, if the value E1 is set so that Pa has a small value, a pulse only rarely appears at the node B. Even when the pulse is integrated, there is little influence in the integration result. Thus, when the effective value of the OFDM signal input to the level detector 200 varies between V0/2 and 2 V0, the value of E1 is set to satisfy a condition of E1=0.5 V0+Vdc. In this case, the value of Pa is within a range of 16% to 40%, in which the influence of a pulse properly appears in the integration result. Therefore, by omitting the pulse width extending circuit 120 with properly setting the value of E1 as described above, accurate level detection can be realized without pulses overlapping in the integration input.

In the level detector 200, when the value of E1 is set as described above, the influence of noise may be apt to appear. In a certain case, for example, the S/N ratio between an OFDM received signal and noise in the receiver 1000 is about 6 dB, which corresponds to one half the signal in the amplitude ratio. The OFDM signal itself may contain noise, or noise may be generated in the receiver 1000. Further, noise may result from both causes. In particular, when the average strength of the received signal is low, noises generated in circuits in the receiver 1000 are dominant. In many cases, the noises generated in the circuits in the receiver 1000 are normally distributed, which are so-called gaussian noise. Therefore, when the S/N ratio is 6 dB to the signal of the effective value V0 and the value of E1 has been set to satisfy the condition of E1=0.5 V0+Vdc, the probability with which noise Van(t) is more than E1 is 16%, which is considerably high. In this case, an excrescent pulse appearing in the signal output from the comparator CMP1 due to noise may cause the integration result by the integrating circuit 120 to considerably differ from the original average strength of the received signal.

As described above, in the level detector 100 or 200, by properly setting the value of E1 in accordance with the variation range of the average strength of the OFDM signal, the strength of the signal output from the level detector 100 or 200 can accurately indicate the average strength of the OFDM signal. Nevertheless, when pulses overlap each other or the influence of noise can not be ignored, the strength of the signal output from the level detector 100 or 200 may not the accurate average strength.

However, the level detector 100 or 200 of this embodiment is used in the AGC circuit. Therefore, the output signal from the level detector 100 or 200 having the above-described characteristics is properly utilized as follows. Interferences contained in the frequency bands other than the target frequency band have been removed from the signal output from the filter circuit 803. Thus, of the OFDM signal, the target frequency band and the noise component contained in the band are input to the level detector 100. In the level detector 100, when noise is ignored, the strengths of the input signal of the level detector are normally distributed. The reason why the noise can be ignored will be described later. Therefore, in the stationary state, when Pa has been set to a relatively low value, for example, 1%, a pulse generated in the comparing circuit 110 appears with a very low frequency. In addition, overlapping of pulses expanded by the pulse width extending circuit 120 is suppressed. In this case, the output signal from the level detector 100 satisfies the above Expression 6, and thus accurately indicates the average strength of the signal output from the filter circuit 803.

On the other hand, when the stationary state has not yet been realized and the output signal from the filter circuit 803 has a high average strength, Pa has a relatively high value. In this case, pulses expanded by the pulse width extending circuit 120 may overlap each other. When the pulses thus overlap each other, the average strength indicated by the output signal from the level detector 100 is evaluated to a value lower than the average strength of the signal actually output from the filter circuit 803.

However, although the average strength indicated by the output signal from the level detector 100 is evaluated to a lower value, it is still higher than the average strength in the stationary state. Therefore, the AGC circuit operates so as to reduce the gain of the variable gain amplifier 801. Thus, the function of the AGC circuit is maintained though the time period for realizing the stationary state becomes relatively long. That is, as for indication of the signal strength necessary for the AGC circuit, the accurate value may not always be indicated. It is only necessary to indicate the magnitude relation to a desired value. The same applies to a case in which the influence of noise can not be ignored in the level detector 200. As described above, by being used in the AGC circuit as in this embodiment, the level detector 100 or 200 is properly used.

As for noise contained in the target frequency band, when the noise is gaussian noise and the S/N ratio is 6 dB, a relatively low value of Pa, for example, 1%, brings about an extremely low value of Pa of noise as 1.6 ppm in the stationary state. Therefore, pulses generated in the comparing circuit 110 due to noise have almost no influence in comparison with the frequency of appearance of pulses caused by the original signal strength. That is, the noise strength scarcely appears in the signal output from the level detector 100. On the other hand, even when noises are not normally distributed, in general, a peak coefficient that is a ratio between the maximum value and the effective value of the noise strength is smaller than the peak coefficient of the normal distribution. Therefore, also in this case, pulses caused by noise can be ignored. In the normal distribution, the peak coefficient changes in accordance with how the maximum value is defined. When the maximum value is defined so that the value obtained by the above Expression 7 is 1%, the peak coefficient of the normal distribution is 2.33. On the other hand, for example, the peak coefficient of a sine wave is 1.41.

### Second Embodiment

Next, a second embodiment of the present invention will be described with reference to FIG. 6. FIG. 6 is a circuit diagram showing a construction of a pulse width extending circuit 320 according to the second embodiment. In the second embodiment, the pulse width extending circuit 120 of the first embodiment is replaced by the pulse width extending circuit 320. The description of the parts other than the parts different from the first embodiment will be arbitrarily omitted below. The same components as in the first embodiment are denoted by the same references as in the first embodiment, respectively.

The pulse width extending circuit 320 includes therein a diode D2, a capacitor C2, a resistor R2, and a comparator CMP2. The anode of the diode D2 is connected to the output terminal of the comparing circuit 110 through an input terminal 321. Either of one ends of the capacitor C2 and the resistor R2 is connected to the cathode of the diode D2. Either of the other ends of the capacitor C2 and the resistor R2 is grounded. The inverting input of the comparator CMP2 is connected to the cathode of the diode D2. The output terminal 322 of the comparator CMP2 is connected to the input terminal of the integrating circuit 130.

The pulse width extending circuit 320 further includes therein resistors R21 and R22, and a diode D21. Either of one ends of the resistors R21 and R22 is connected to the non-inverting input of the comparator CMP2. The other end of the resistor R21 is connected to the cathode of the diode D21. The other end of the resistor R22 is grounded. The anode of the diode D21 is connected to a power supply VDD that always supplies the voltage Vdd.

The diodes D21 and D2 have substantially the same circuit characteristics. The resistors R21 and R22 have substantially the same circuit characteristics as the resistor R2 except their resistance values. A condition of R2=(R21+R22) is satisfied. The diodes D2 and D21; and the resistors R2, R21, and R22 are preferably disposed as close to each other as possible. For this purpose, when the level detector of this embodiment is realized by using individual parts, a diode array and a resistor array are preferably used. When the level detector of this embodiment is realized in an integrated circuit (IC), the above condition will be satisfied.

In the pulse width extending circuit 120 of FIG. 2, the forward voltage Vf of the diode D2 may vary in accordance with the ambient temperature and the manufacturing variation. In addition, the value of Vth of the inverter INV2 may also vary in accordance with the ambient temperature and the manufacturing variation. Further, the power supply voltage Vdd may vary in accordance with the ambient temperature or the like; and the resistance value of the resistor R2 may vary in accordance with the ambient temperature and the manufacturing variation. In such a case, the value of PWa obtained by the above Expression 3 varies. The variation of PWa brings about error in the output voltage Ve(t) of the level detector obtained by the above Expression 6.

Contrastingly in the second embodiment having the above-described construction, because the diodes D2 and D21 are similar in the ambient temperature, and have the same circuit characteristics, the forward currents of the same value flow through the diodes. Therefore, the forward voltages of the diodes have the same value of Vf. Thus, the diode D21 is always in the conduction state, and the voltage at the cathode of the diode D21 is equal to the voltage V2=(Vdd−Vf) at the cathode of the diode D2 in the conduction state.

On the other hand, the voltage at the non-inverting input of the comparator CMP2 is Vth=V2×R22/(R21+R22). As described above, the resistors are disposed close to each other, and have the same circuit characteristics. Therefore, the relative variations in temperature and manufacturing process from resistor to resistor are considerably little. Thus, the value of V2/Vth is substantially fixed, and a substantially fixed value of PWa is obtained by the above Expression 3. Thus, in this embodiment, the value of PWa substantially only depends on the values of C2 and R2. This can eliminate variation factors by the power supply voltage Vdd, the forward voltage Vf of each diode, and Vth.

Variations in the capacitance value C2 and the resistance value R2 may matter when the capacitor C2 and the resistor R2 are formed in an IC. In such an IC, the value of (C2×R2) varies by about plus or minus 40% at the maximum due to the manufacturing variation. When the variation is applied to the case of the first embodiment, the value of PWa varies in a range of 35 PW to 69 PW though PWa=49 PW with no variation. However, when the variation in Pa is derived within the range of the variation in PWa by using the above Expression 8, and further the variation in the effective value of Va(t) is calculated back from the variation in Pa, the variation to the original effective value in the signal output from the filter circuit 802 in the stationary state falls within a range of plus or minus 6%. Therefore, even when the value of C2 or R2 widely varies, only a narrow variation appears in the output from the level detector. When variation of about 6% is permissible in the input signal of the level detector, correction for the variations in C2 and R2 is unnecessary. On the other hand, when the variation of about 6% is not permissible, the variations in the capacitor and the resistor can be corrected by further using a known technique generally used when such a filter circuit is realized in an IC.

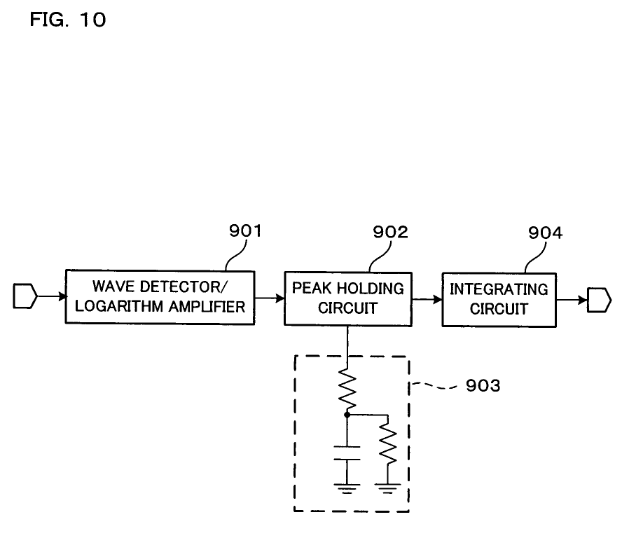

In the prior art level detector 900 shown in FIG. 10, the logarithm amplifier 901 is very susceptible to temperature variation because the amplifier uses non-linear characteristics of a semiconductor such as a diode and a transistor used in the circuit. For this reason, it is required to separately provide a circuit for compensating the temperature variation. For example, the above-described Japanese Patent Unexamined Publication No. 2000-134163 discloses an example of a temperature compensating circuit using a thermistor. However, because the temperature characteristic of the thermistor does not completely correspond to the temperature characteristic of the above semiconductor, the temperature compensation by the temperature compensating circuit using the thermistor is incomplete. Contrastingly in the second embodiment, because variations are corrected by using the same diodes and the same resistors in characteristics, the variations are more properly corrected in comparison with the case of using the above-described temperature compensating circuit.

### Third Embodiment

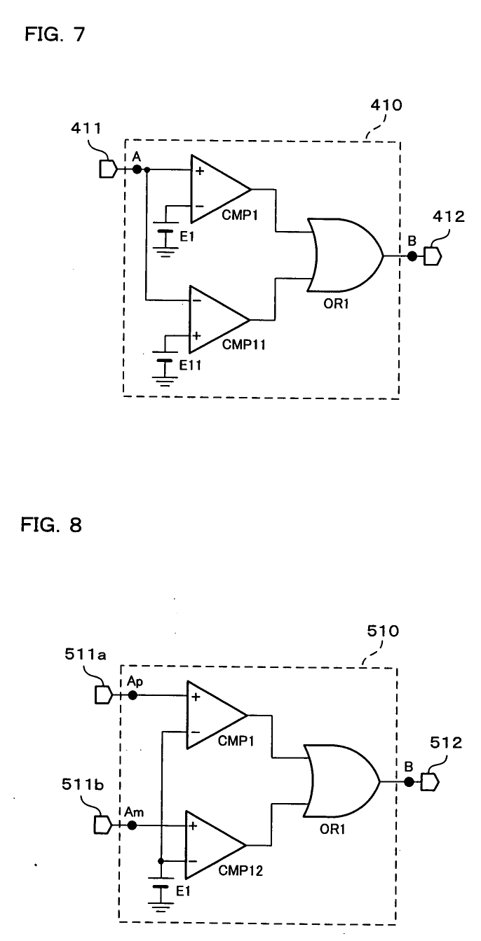

Next, a third embodiment of the present invention will be described with reference to FIG. 7. FIG. 7 is a circuit diagram showing a construction of a comparing circuit 410 according to the third embodiment. In the third embodiment, the comparing circuit 110 of the first embodiment is replaced by the comparing circuit 410. The description of the parts other than the parts different from the first embodiment will be arbitrarily omitted below. The same components as in the first embodiment are denoted by the same references as in the first embodiment, respectively.

An OFDM signal is input to the comparing circuit 410 from the filter circuit 803 through an input terminal 411. The comparing circuit 410 includes therein comparators CMP1 and CMP11; DC power supplies E1 and E11; and an OR circuit OR1. The non-inverting input of the comparator CMP1 and the inverting input of the comparator CMP11 are connected to the input terminal 411. The inverting input of the comparator CMP1 is connected to the positive terminal of the DC power supply E1. The non-inverting input of the comparator CMP11 is connected to the positive terminal of the DC power supply E11. The negative terminals of the DC power supplies E1 and E11 are grounded. The output terminals of the comparators CMP1 and CMP11 are connected to the input terminal of the OR circuit OR1. The output terminal 412 of the OR circuit OR1 is connected to the input terminal of the pulse width extending circuit 120.

The OR circuit OR1 has two input terminals. The OR circuit OR1 implements the logical OR operation between the signals input through the respective input terminals so that pulses contained in the signals are combined to generate one pulse signal. The value of E11, as a second reference value, has been set so that a relation of E11 to the DC voltage Vdc when the input signal has no variation, and E1, is obtained by the following Expression 9, as shown in the graph (a) of FIG. 4.

E11=Vdc−(E1−Vdc)=2Vdc−E1 [Expression 9]

When the voltage of a part of the input signal having its voltage lower than Vdc is lower than E11, the comparator CMP11 outputs a fixed value Vdd. Thereby, the comparator CMP11 outputs, for example, a pulse of the voltage Vdd corresponding the time period from t7 to t8 in the graph (a) of FIG. 4. On the other hand, the comparator CMP1 outputs a pulse corresponding to a part of the input signal having its voltage higher than E1. The OR circuit OR1 combines the pulses from the comparators CMP1 and CMP11, and outputs the combined pulse. Therefore, when Pa represents the probability with which the voltage of the signal at the node A is higher than E1; and Pa′ represents the probability with which the voltage of the signal at the node A is lower than E11, the probability with which a pulse of the voltage Vdd appears at the node B is the sum of Pa and Pa′. That is, when the comparing circuit 410 of this embodiment is used in the level detector, Pa is replaced by (Pa+Pa′) in the above Expression 6 to obtain the output signal from the level detector. The value of Pa′ is obtained by the following Expression 10.

$$\begin{matrix}P {a}^{′} = \frac{1}{\sqrt{2 π} Vev} {\int }_{- ∞}^{E 11} {e}^{- {( x - Vdc )}^{2} / 2 {Vev}^{2}} d x \\ = \frac{1}{\sqrt{2 π}} {\int }_{( Vdc - E 11 )}^{∞} {e}^{- {y}^{2} / 2} d y\end{matrix} \qquad [ Expression 10 ]$$

The DC voltage Vdc may vary by various causes. The variation in the DC voltage Vdc leads to variation in the probability Pa with which the voltage of the input signal of the level detector is higher than E1. This brings about variation in the result of integration of the pulses corresponding to the time period during which the voltage is higher than E1. Therefore, there is possibility that the output signal from the level detector does not accurately indicate the average strength of the OFDM signal.

In this embodiment, however, error due to the variation in the DC voltage Vdc is suppressed as will be described below. When the above Expression 9 is satisfied, a condition of Pa=Pa′ is satisfied from the above Expressions 7 and 10. Thus, when the values of E1 and E11 have been set so that Pb=1%, that is, Pa=Pa′=0.5%, the values of E1 and E11 are E1=(2.58 Vev+Vdc) and E11=(−2.58 Vev+Vdc), where Vev represents the effective value of the voltage Va(t) at the node A.

When the value of Vdc increases by 10% the value of Vev from the above state, the probability with which the voltage is higher than E1 in Va(t) increases, and therefore the rate at which the comparator CMP1 generates a pulse increases. More specifically, the value of Pa becomes Pa=0.66%. On the other hand, because the probability with which the voltage is lower than E11 in Va(t) decreases, the rate at which the comparator CMP11 generates a pulse decreases. More specifically, the value of Pa′ becomes Pa′=0.37%. Therefore, Pa+Pa′=1.03%. That is, even when the value of Vdc increases by 10% the value of Vev, the value of Pa+Pa′ after the increase in Vdc only somewhat exceeds the value of Pa+Pa′=1% before the increase in Vdc. Contrastingly in the first embodiment, when the value of Vdc increases by 10% the value of Vev under the same conditions, the value of Pa becomes Pa=1.29%, which has widely varied from Pa=1%. As described above, in the third embodiment, the decrease in pulses in the comparator CMP 11 cancels the increase in pulses in the comparator CMP1. That is, this embodiment is resistant to variation in the DC voltage of the input signal.

### Fourth Embodiment

Next, a fourth embodiment of the present invention will be described with reference to FIG. 8. FIG. 8 is a circuit diagram showing a construction of a comparing circuit 510 according to the fourth embodiment. In the fourth embodiment, the comparing circuit 110 of the first embodiment is replaced by the comparing circuit 510. The description of the parts other than the parts different from the first embodiment will be arbitrarily omitted below. The same components as in the first embodiment are denoted by the same references as in the first embodiment, respectively.

The fourth embodiment is applied to a case in which a number of signals are input to the comparing circuit, for example, a case in which the input signals form a differential signal. To the comparing circuit 510, the positive signal of a differential signal is input through an input terminal 511a; and the negative signal of the differential signal is input through an input terminal 511b. The comparing circuit 510 includes therein comparators CMP1 and CMP12; a DC power supply E1; and an OR circuit OR1. The non-inverting input of the comparator CMP1 is connected to the input terminal 511a. The non-inverting input of the comparator CMP12 is connected to the input terminal 511b. The inverting inputs of the comparators CMP1 and CMP12 are connected to the positive terminal of the DC power supply E1. The negative terminal of the DC power supply E1 is grounded. The output terminals of the comparators CMP1 and CMP12 are connected to the input terminal of the OR circuit OR1. The output terminal 512 of the OR circuit OR1 is connected to the input terminal of the pulse width extending circuit 120.

The comparator CMP1 outputs a pulse corresponding to a time period during which the voltage of the input signal from the input terminal 511a is higher than E1. The comparator CMP12 also outputs a pulse corresponding to a time period during which the voltage of the input signal from the input terminal 511b is higher than E1. The OR circuit OR1 combines the pulses from the comparators CMP1 and CMP12 to output a combined pulse.

In the case of a differential signal, it is thinkable that one of the positive and negative signals of the differential signal is input to the comparing circuit of the above-described third embodiment. However, although the comparing circuit 410 of the third embodiment can cope with variation in the common mode DC voltage of the differential signal, it can not cope with variation in the DC voltage due to the DC offset voltage of the differential signal. In many cases, a DC offset voltage is generated in such a differential signal. Therefore, there is relatively large possibility that the third embodiment can not cope with the differential signal input.

Contrastingly, as will be described below, the comparing circuit 510 of this fourth embodiment has its construction particularly suitable for a case in which a DC offset voltage is apt to be generated. When Vof represents the DC offset voltage to the differential signal Vad(t) input to the comparing circuit 510, the positive and negative signals Vap(t) and Vam(t) of the differential signal are obtained by the following Expression 11.

$$Vap ( t ) = \frac{Vad ( t )}{2} + \frac{Vof}{2} \\ Vam ( t ) = - \frac{Vad ( t )}{2} - \frac{Vof}{2} \qquad [ Expression 11 ]$$

In the signal Vap(t), the ratio of the time period during which the voltage is more than E1 increases by +Vof/2 in comparison with the case that no DC offset voltage Vof is generated. Therefore, when the signal Vap(t) is input to the comparator CMP1, the frequency of appearance of pulses increases in comparison with the case that no DC offset voltage Vof is generated. On the other hand, in the signal Vam(t), the ratio of the time period during which the voltage is more than E1 decreases by −Vof/2 in comparison with the case that no DC offset voltage Vof is generated. Therefore, when the signal Vam(t) is input to the comparator CMP12, the frequency of appearance of pulses decreases in comparison with the case that no DC offset voltage Vof is generated. Thus, in the frequency of appearance of pulses in the signal output from the OR circuit OR1, variation is suppressed from the case that no DC offset voltage Vof is generated.

### Fifth Embodiment

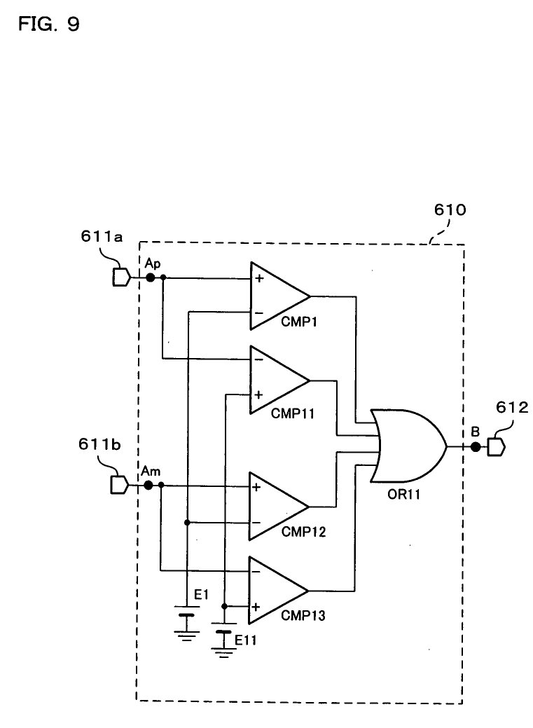

Next, a fifth embodiment of the present invention will be described with reference to FIG. 9. FIG. 9 is a circuit diagram showing a construction of a comparing circuit 610 according to the fifth embodiment. In the fifth embodiment, the comparing circuit 110 of the first embodiment is replaced by the comparing circuit 610. The description of the parts other than the parts different from the first embodiment will be arbitrarily omitted below. The same components as in the first embodiment are denoted by the same references as in the first embodiment, respectively.

The fifth embodiment is applied to a case in which a number of signals are input to the comparing circuit, like the fourth embodiment. To the comparing circuit 610, the positive signal of a differential signal is input through an input terminal 611b; and the negative signal of the differential signal is input through an input terminal 611b. The comparing circuit 610 includes therein comparators CMP1, CMP11, CMP12, and CMP13; DC power supplies E1 and E11; and an OR circuit OR11. The non-inverting input of the comparator CMP1 and the inverting input of the comparator CMP 11 are connected to the input terminal 611a. The non-inverting input of the comparator CMP12 and the inverting input of the comparator CMP 13 are connected to the input terminal 611b. The inverting inputs of the comparators CMP1 and CMP12 are connected to the positive terminal of the DC power supply E1. The non-inverting inputs of the comparators CMP11 and CMP13 are connected to the positive terminal of the DC power supply E11. The negative terminals of the DC power supplies E1 and E11 are grounded. The output terminals of the comparators CMP1 to CMP 13 are connected to the input terminal of the OR circuit OR11. The output terminal 612 of the OR circuit OR11 is connected to the input terminal of the pulse width extending circuit 120.

The comparator CMP1 outputs a pulse corresponding to a time period during which the voltage of the input signal from the input terminal 611a is higher than E1. The comparator CMP12 outputs a pulse corresponding to a time period during which the voltage of the input signal from the input terminal 611b is higher than E1. The comparator CMP11 outputs a pulse corresponding to a time period during which the voltage of the input signal from the input terminal 611a is lower than E11. The comparator CMP13 outputs a pulse corresponding to a time period during which the voltage of the input signal from the input terminal 611b is lower than E11. The OR circuit OR11 combines the pulses from the comparators CMP1 to CMP13 to output a combined pulse.

The above-described fourth embodiment is applied to a case in which only a DC offset signal is apt to be generated. Contrastingly, as will be described below, this fifth embodiment can cope with both of variation in the common mode DC voltage, and the DC offset signal. When Vcdc represents the common mode DC voltage and Vof represents the DC offset voltage to the differential signal Vad(t) input to the comparing circuit 610, the positive and negative signals Vap(t) and Vam(t) of the differential signal are obtained by the following Expression 12.

$$Vap ( t ) = \frac{Vad ( t )}{2} + Vcdc + \frac{Vof}{2} \\ Vam ( t ) = - \frac{Vad ( t )}{2} + Vcdc - \frac{Vof}{2} \qquad [ Expression 12 ]$$

When the signals Vap(t) and Vam(t) are input through the respective input terminals 611a and 611b, variation in the frequency of appearance of pulses in the comparing circuit 610 is cancelled as follows. The variation in the frequency of appearance of pulses due to the common mode DC voltage Vcdc is cancelled between the comparators CMP1 and CMP11 and between the comparators CMP12 and CMP13, like the third embodiment. The variation in the frequency of appearance of pulses due to the DC offset voltage Vof is cancelled between the comparators CMP1 and CMP12 and between the comparators CMP11 and CMP13, like the fourth embodiment. Thus, this fifth embodiment realizes a level detector that can suppress the variation in the frequency of appearance of pulses due to either DC voltage variation in the common mode DC voltage and the DC offset voltage.

(Modifications)

Some preferred embodiments of the present invention have been described. However, the present invention is never limited to the above-described embodiments. Various changes can be made in the above-described embodiments within the scope of the invention.

In the above-described embodiments, the integrating circuit 130 is ideally made of a primary low-pass filter whose gain can be infinite. Actually, however, the DC gain of the operational amplifier OPA3 is finite, ant thus the DC gain of the integrating circuit 130 is also finite. Even in such a case, when the cutoff frequency of the filter is sufficiently lower than the inverse of the pulse period of the input signal, there arises no substantially problem. Therefore, if the cutoff frequency of the filter can be set to be sufficiently lower than the inverse of the pulse period of the input signal, the integrating circuit 130 can be replaced by a low-pass filter having another construction. Even in that case, the strength of the output signal from the filter indicates the average strength of the input signal.

In the above-described first embodiment, the value of E1 is higher than the value of Vdc. In a modification, however, the comparing circuit may be constructed as follows. The non-inverting input of the comparator CMP1 is connected to the power supply E1; and the inverting input of the comparator CMP1 is connected to the input signal. In this state, the value of E1 is set to be lower than the value of Vdc. In addition the comparing circuit is designed so that the comparator CMP1 outputs a pulse of the voltage Vdd during the time period in which the voltage of the input signal Va(t) is higher than E1. There is only a difference whether the positive or negative side of Va(t) is used for Vdc. In any case of the positive and negative sides used, the frequency of appearance of instantaneous signal strengths is the same.

In the above-described embodiments, the power supply E1 is represented by a symbol of a battery cell in FIG. 3. In a modification, however, another power supply than such a battery cell may be used. In addition, when the strength of an input signal may widely change, a variable power supply E1 can be used so as to cope with the wide change in the strength of the input signal.

In the above-described embodiments, the term “grounded” does not always mean that the ground voltage zero volt is supplied. For example, each terminal may be only connected to a metallic casing of the receiver 1000.

In the above-described third to fifth embodiments, a differential signal is input. However, the present invention can be applied to a case of intending to detect an average strength of a number of signals other than such a differential signal. That is, by adding a comparator to which the signals are input, and adding the output of the comparator to the OR circuit, the average strength of the signals can be detected. For example, in the case of a receiver 1000 using a direct conversion system, a quadrature mixer is used as the mixer circuit 802, and thereby base band signals of two components of the in-phase component I and the quadrature component Q are obtained. The two-components base band signals pass through the filter circuit 803, and they are finally demodulated. In an OFDM signal, those two components have originally substantially the same average strength. Therefore, only one component can be input to the level detector to obtain an average signal. However, as in the third to fifth embodiments, both components can be used as inputs of the level detector. Thereby, in the mixer circuit 802 and the filter circuit 803, deviation of level detection error can be eliminated when gain mismatch occurs between the components I and Q.

In the above-described third to fifth embodiments, the comparing circuit 110 of the first embodiment is replaced by the comparing circuits 410 to 610, respectively. In other modifications, however, the comparing circuit 110 of the second embodiment may be replaced by the comparing circuits 410 to 610, respectively.

As described in the above first to fifth embodiments, the level detector of each embodiment is most suitable for a case in which instantaneous strengths of the input signal are normally distributed, as an OFDM signal. However, the level detector of each embodiment can be also applied to a case of a CDMA signal having a large multiple number because its strengths are normally distributed. Further, even in the case of a signal whose instantaneous strengths are not normally distributed, when the higher instantaneous strength has the lower probability of appearance, an increase in the average strength brings about an increase in the probability with which the voltage of the signal is higher than the reference value E1. Therefore, even in the case of such a signal, the fact remains that the above Expression 6 gives an average strength of the signal. That is, the level detector of each embodiment can be also applied to such a signal. Therefore, other than the receiver 1000 of the above-described embodiments, the level detector of each embodiment can be used in a circuit, such as other wireless and wired receivers; wireless and wired transmitters; various audio devices; and various sound devices, necessary for detecting an average strength in an AGC circuit or the like.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A level detector comprising:
a signal input;
a comparing circuit that generates a signal comprising a plurality of temporally successive pulses each having its width corresponding to the length of a time period during which the strength of an input signal from the input is higher than a first reference value; and
an integrating circuit that outputs a signal having its strength corresponding to an integration value obtained by temporally integrating the strength of the signal generated by the comparing circuit.

2. A level detector comprising:
a signal input;
a comparing circuit that generates a signal comprising a plurality of temporally successive pulses each having its width corresponding to the length of a time period during which the strength of an input signal from the input is lower than a second reference value; and
an integrating circuit that outputs a signal having its strength corresponding to an integration value obtained by temporally integrating the strength of the signal generated by the comparing circuit.

3. The detector according to claim 1, further comprising a pulse width extending circuit that generates a signal in which each pulse contained in the signal generated by the comparing circuit has been temporally extended; and outputs the generated signal to the integrating circuit.

4. The detector according to claim 3, wherein the pulse width extending circuit comprises:
a first diode to the anode of which the signal generated by the comparing circuit is input;
a first resistor whose one end is connected to the cathode of the diode, and whose other end is grounded; and
a capacitor whose one end is connected to the cathode of the diode, and whose other end is grounded, and the pulse width extending circuit outputs to the integrating circuit a pulse having its width corresponding to the length of a time period during which the voltage being stored in the capacitor is higher than a reference voltage value.

5. The detector according to claim 4, wherein the pulse width extending circuit further comprises:
a second diode having substantially the same circuit characteristics as the first diode;
a second resistor having substantially the same circuit characteristics as the first resister; and
a pulse width extending comparator comprising a first input terminal connected to the cathode of the first diode, and a second input terminal connected to both of the second diode and the second resistor, the pulse width extending comparator outputting to the integrating circuit a pulse corresponding to the length of a time period during which the voltage at the first input terminal is higher than the voltage at the second input terminal, and
the second diode and resistor are connected to the second input terminal so as to reduce variation generated in the width of the pulse to be output from the pulse width extending comparator, due to at least one of the circuit characteristics and temperature variations of the first diode and resistor.

6. A level detector comprising:
a signal input;
a first comparing circuit that generates a signal comprising a plurality of temporally successive pulses each having its width corresponding to the length of a time period during which the strength of an input signal from the input is higher than a first reference value;
a second comparing circuit that generates a signal comprising a plurality of temporally successive pulses each having its width corresponding to the length of a time period during which the strength of the input signal from the input is lower than a second reference value lower than the first reference value;
an OR circuit that generates a signal having its strength corresponding to the logical sum of the signal generated by the first comparing circuit and the signal generated by the second comparing circuit;
a pulse width extending circuit that generates a signal in which each pulse contained in the signal generated by the OR circuit has been temporally extended; and
an integrating circuit that outputs a signal having its strength corresponding to an integration value obtained by temporally integrating the strength of the signal generated by the pulse width extending circuit.

7. A level detector comprising:
first to n-th signal inputs corresponding to n input signals, where n represents a natural number more than one;
first to n-th comparing circuits each of which generates a signal comprising a plurality of temporally successive pulses each having its width corresponding to the length of a time period during which the strength of an input signal from the corresponding one of the first to n-th inputs is higher than a first reference value;
an OR circuit that generates a signal having its strength corresponding to the logical sum of the signals generated by the first to n-th comparing circuits;
a pulse width extending circuit that generates a signal in which each pulse contained in the signal generated by the OR circuit has been temporally extended; and
an integrating circuit that outputs a signal having its strength corresponding to an integration value obtained by temporally integrating the strength of the signal generated by the pulse width extending circuit.

8. The detector according to claim 7, wherein the detector further comprises (n+1)th to 2n-th comparing circuits each of which generates a signal comprising a plurality of temporally successive pulses each having its width corresponding to the length of a time period during which the strength of the input signal from the corresponding one of the first to n-th inputs is lower than a second reference value lower than the first reference value, and
the OR circuit generates a signal having its strength corresponding to the logical sum of the signals generated by the first to 2n-th comparing circuits.

9. A communication apparatus comprising:
an input to which a communication signal is input;
a comparing circuit that generates a signal comprising a plurality of temporally successive pulses each having its width corresponding to the length of a time period during which the strength of the input signal from the input is higher than a predetermined reference value; and
an integrating circuit that outputs a signal having its strength corresponding to an integration value obtained by temporally integrating the strength of the signal generated by the comparing circuit,
the apparatus detecting the level of the communication signal on the basis of the output from the integrating circuit.

10. A tuner comprising:
an amplifier that amplifies an input signal and then outputs the amplified signal;
a channel selecting unit that applies a channel selecting process to the signal output from the amplifier;
a comparing circuit that generates a signal comprising a plurality of pulses each having its width corresponding to the length of a time period during which the strength of the signal channel-selecting-processed by the channel selecting unit is higher than a predetermined reference value;
an integrating circuit that outputs a signal having its strength corresponding to an integration value obtained by temporally integrating the strength of the signal generated by the comparing circuit; and
a gain controller that decreases the gain of the amplifier in accordance with the degree that the strength of the signal output from the integrating circuit is higher than a desired value; and increases the gain of the amplifier in accordance with the degree that the strength of the signal output from the integrating circuit is lower than the desired value.
